(19) United States
(12) Patent Application Publication
(10) Pub. No.: US 2026/0018948 A1
(43) Pub. Date: Jan. 15, 2026

(54) INTERIOR PERMANENT MAGNET ROTOR

(71) Applicant: ISUZU MOTORS LIMITED, Yokohama-shi (JP)

(72) Inventor: Yusuke TAKAHASHI, Fujisawa-shi (JP)

(21) Appl. No.: 19/251,877

(22) Filed: Jun. 27, 2025

(30) Foreign Application Priority Data
Jul. 10, 2024 (JP) 2024-111022

(51) Int. Cl. H02K 1/276

(52) U.S. Cl. CPC H02K 1/276

(57) ABSTRACT

A rotor includes a rotor core having i) a plurality of magnet insertion holes formed at predetermined intervals in a circumferential direction and into which magnets are inserted and ii) a void section communicating with one end of each of the plurality of magnet insertion holes, a yoke provided inside each of a plurality of the void sections so as to be movable in a radial direction of the rotor core, and an elastic member provided inside each of the plurality of the void sections and pressing the yoke in the radial direction.

### CROSS-REFERENCE TO RELATED APPLICATIONS

The present application claims priority to Japanese Patent Application number 2024-111022, filed on Jul. 10, 2024, contents of which are incorporated herein by reference in its entirety.

### BACKGROUND OF THE INVENTION

The present disclosure relates to an interior permanent magnet rotor.

A rotor of a conventional interior permanent magnet synchronous motor is provided with a hole for preventing magnetic flux leakage, the hole being formed from an end of a magnet insertion hole in the circumferential direction to a bridge located in the rotor close to its outer peripheral portion, thereby preventing magnetic short-circuiting in the rotor (for example, Japanese Unexamined Patent Application Publication No. 2014-87074).

A rotor becomes less prone to magnetic flux leakage within the rotor as a radial width of its bridge is reduced, allowing a greater amount of magnetic flux to interlink with a coil. However, since an induced voltage is generated in the coil, it becomes difficult to allow current to flow. To address this issue, it is conceivable to employ the field weakening control. However, when a rotational speed of the rotor is increased by the field weakening control, the amount of current that does not contribute to rotor rotation increases, resulting in greater loss (copper loss).

### BRIEF SUMMARY OF THE INVENTION

The present disclosure focuses on this point, and an object thereof is to increase a rotational speed of a rotor while suppressing loss.

### Means for Solving the Problems

An interior permanent magnet rotor according to the present disclosure includes a rotor core having i) a plurality of magnet insertion holes formed at predetermined intervals in a circumferential direction and into which magnets are inserted and ii) a void section communicating with one end of each of the plurality of magnet insertion holes, a yoke provided inside each of a plurality of the void sections so as to be movable in a radial direction of the rotor core, and an elastic member provided inside each of the plurality of the void sections and pressing the yoke in the radial direction.

### BRIEF DESCRIPTION OF THE DRAWINGS

FIG. 1 shows an overview of a motor 1 according to the present embodiment.

FIG. 2 shows a configuration of a void section 24.

FIG. 3 shows a configuration of the void section 24 when an elastic member 243 is most compressed.

FIG. 4 shows a second yoke portion 242b not in contact with an end surface S3.

FIG. 5 shows the second yoke portion 242b having a smaller area of contact with the end surface S3.

### DETAILED DESCRIPTION OF THE INVENTION

Hereinafter, the present disclosure will be described through exemplary embodiments, but the following exemplary embodiments do not limit the invention according to the claims, and not all of the combinations of features described in the exemplary embodiments are necessarily essential to the solution means of the invention.

### <Overview of Motor 1>

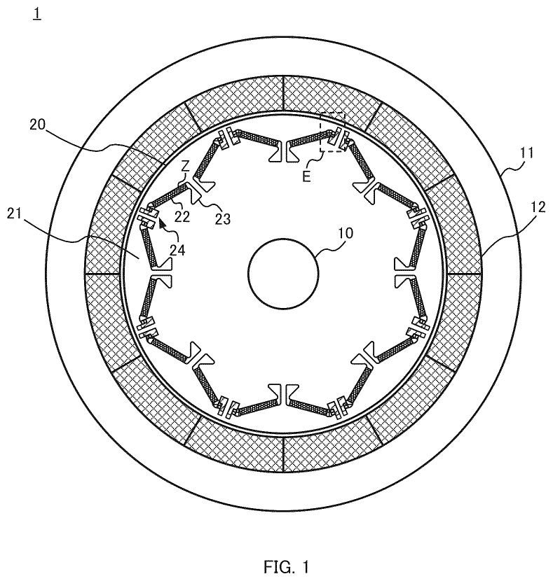

FIG. 1 shows an overview of a motor 1 according to the present embodiment. FIG. 1 is a cross-sectional view along a plane orthogonal to an axial direction of a rotational shaft of the motor 1. The motor 1 is an interior permanent magnet synchronous motor and includes a rotational shaft 10, a stator 11, a coil 12, and a rotor 20.

The stator 11 is disposed around the outside of the rotor 20 and is formed in a cylindrical shape by stacking a ring-shaped soft magnetic material in the axial direction. A plurality of tooth portions are formed on an inner circumference of the stator 11, and the coil 12 is wound around each of the plurality of tooth portions. In FIG. 1, as an example, each of the twelve tooth portions has the coil 12 wound around it. The winding of the coils 12 around the inner circumference of the stator 11 in this manner generates a magnetic field inside the stator 11.

The rotor 20 is a rotor disposed outside the rotational shaft 10 and inside the stator 11, and is an interior permanent magnet rotor that has a plurality of magnets Z embedded therein. The magnet Z is a permanent magnet, for example. The rotor 20 includes a rotor core 21, and the rotor core 21 includes a plurality of magnet insertion holes 22, a plurality of flux barriers 23, and a plurality of void sections 24. In FIG. 1, only one magnet insertion hole 22 out of the plurality of magnet insertion holes 22, one flux barrier 23 out of the plurality of flux barriers 23, one void section 24 out of the plurality of void portions 24, and one magnet Z out of the plurality of magnets Z are denoted by reference numerals.

The rotor core 21 is formed in a cylindrical shape by stacking a ring-shaped soft magnetic material in an axial direction, and is provided to be rotatable in a rotational direction (circumferential direction) of the rotational shaft 10. The plurality of magnet insertion holes 22 are formed at predetermined intervals in the circumferential direction, and the magnets Z are inserted therein. In each magnet insertion hole 22, the magnet Z having the same shape and size as the magnet insertion hole 22 is embedded. The magnet insertion hole 22 is formed to be a rectangular hole whose longitudinal direction is along the circumferential direction of the rotor 20 and which extends in the axial direction, and one of two end portions in the longitudinal direction is closer to the center of the motor 1 than the other end portion.

The flux barrier 23 is formed so as to extend toward an inward position of the motor 1 in its radial direction from the end portion closer to the center of the motor 1 out of the two end portions of the magnet insertion hole 22. The cross-sectional area of the flux barrier 23, taken along a plane orthogonal to the radial direction, increases as the distance from the center of the motor 1 decreases. The flux barrier 23 is formed so as to penetrate the rotor 20 along the axial direction, and the inside of the flux barrier 23 is a void, for example.

The void section 24 is formed so as to extend between inward position and outward position in the radial direction from one of the two end portions of the magnet insertion hole 22 that is farther from the center of the motor 1. An end surface of the void section 24 positioned closer to the inward position is larger than an end surface of the void section 24 positioned closer to the outward position. Each of the plurality of void sections 24 communicates with one end of a corresponding one of the plurality of magnet insertion holes 22, and each of the plurality of flux barriers 23 communicates with the other end of the corresponding magnet insertion hole 22. The void section 24 is formed so as to penetrate the rotor 20 along the axial direction.

An internal configuration of the void section 24 will be described in detail below.

### <Configuration of Void Section 24>

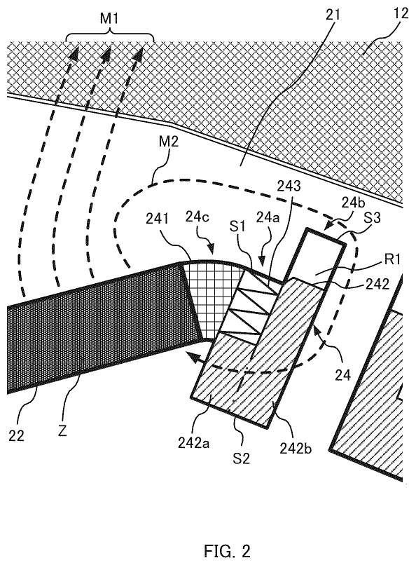

FIG. 2 shows a configuration of the void section 24. FIG. 2 is an enlarged view of a portion E of the motor 1 shown in FIG. 1. FIG. 2 shows magnetic fluxes M1 and M2 generated in a region of the rotor core 21 that is radially outward of the magnet Z. The magnetic flux M1 is a magnetic flux that passes through a surface of the rotor 20 and interlinks with the coil 12, and the magnetic flux M2 is a magnetic flux that passes through a position in the rotor 20 close to its outer peripheral surface and advances toward an end surface of the magnet Z positioned radially inward (a so-called “leakage magnetic flux”).

The void section 24 includes a first void portion 24a, a second void portion 24b, and a third void portion 24c. In the void section 24, the third void portion 24c, the first void portion 24a, and the second void portion 24b are in communication with one another in this order from the side closer to the magnet insertion hole 22 in the circumferential direction.

The first void portion 24a is a rectangular void portion whose longitudinal direction is along the radial direction of the rotor 20, and is located closer to the magnet insertion hole 22 than the second void portion 24b in the circumferential direction.

The second void portion 24b is a rectangular void portion whose longitudinal direction is along the radial direction of the rotor 20, and communicates in parallel with the first void portion 24a. The inner peripheral surface of the second void portion 24b positioned radially inward is located at the same position as the inner peripheral surface of the first void portion 24a positioned radially inward. On the other hand, the inner peripheral surface of the second void portion 24b positioned radially outward is positioned farther radially outward than the inner peripheral surface of the first void portion 24a positioned radially outward. Therefore, the second void portion 24b is longer than the first void portion 24a in the radial direction.

The third void portion 24c is located between the magnet insertion hole 22 and the first void portion 24a in the circumferential direction, and is curved to allow the magnet insertion hole 22 and the first void portion 24a to communicate with each other. The third void portion 24c here has a fan shape.

The void section 24 is provided with a support part 241, a yoke 242, and an elastic member 243. The yoke 242 includes a first yoke portion 242a and a second yoke portion 242b. In the first void portion 24a, the first yoke portion 242a is movable in the radial direction, and the elastic member 243 is expandable and contractible. In the second void portion 24b, the second yoke portion 242b is movable in the radial direction. The support part 241 is located in the third void portion 24c.

The support part 241 is provided to fill the third void portion 24c in each of the plurality of third void portions 24c, and is formed to curve from an end surface of the magnet Z to the elastic member 243. The support part 241 here has a fan shape. The support part 241 is provided between the magnet Z and the elastic member 243 (that is, the third void portion 24c) in each of the plurality of void portions 24, and prevents the elastic member 243 from moving toward the magnet Z. The support part 241 is formed of a non-magnetic material, and prevents the magnetic flux M2 generated in the region of the rotor core 21 that is radially outward of the magnet Z from passing between the magnet Z and the elastic member 243 without bypassing an area beyond the distal end of the second void portion 24b as viewed from the magnet Z (a so-called “short circuit”).

The yoke 242 is formed of a magnetic material, and is provided inside each of the plurality of void sections 24 to be movable in the radial direction of the rotor core 21. Since a centrifugal force generated by the rotation of the motor 1 acts on the yoke 242 from the radially inner position toward the radially outer position, the yoke 242 moves in the radial direction by pressing against, or being pressed by, the elastic member 243 in accordance with the magnitude of the centrifugal force.

The yoke 242 includes a first yoke portion 242a located closer to the magnet insertion hole 22 in the circumferential direction, and a second yoke portion 242b that is located farther from the magnet insertion hole 22 in the circumferential direction and is longer than the first yoke portion 242a in the radial direction. In FIG. 2, a boundary between the first yoke portion 242a and the second yoke portion 242b is indicated by a one-dot chain line, and a portion closer to the magnet insertion hole 22 in the circumferential direction than the one-dot chain line is the first yoke portion 242a, and a portion farther from the magnet insertion hole 22 in the circumferential direction than the one-dot chain line is the second yoke portion 242b. The first yoke portion 242a is connected to the second yoke portion 242b so that the end surface of the first yoke portion 242a positioned radially inward is located at the same position as the end surface of the second yoke portion 242b positioned radially inward. A length of the second yoke portion 242b in the radial direction is greater than a length of the first void portion 24a in the radial direction.

The elastic member 243 is a compression spring, and presses the yoke 242 in the radial direction inside each of the plurality of void portions 24. As shown in FIG. 2, the elastic member 243 is provided between an end surface S1 of the void section 24 and the first yoke portion 242a, along the radial direction. The elastic member 243 is formed of a non-magnetic material, and prevents a short circuit of the magnetic flux M2 generated in a region of the rotor core 21 that is radially outward of the magnet Z.

The elastic member 243 is pressed radially outward by the first yoke portion 242a as a result of the centrifugal force acting on the yoke 242 due to the rotation of the motor 1. When the rotational speed of the motor 1 is equal to or lower than a base rotational speed, the elastic member 243 does not compress even if pressed by the yoke 242 since the elastic force of the elastic member 243 is equal to or greater than the centrifugal force. The base rotational speed is a rotational speed at which the rotor 20 can rotate without executing the field weakening control, and is a fixed value between 3000 rpm and 5000 rpm, for example. Therefore, as shown in FIG. 2, the first yoke portion 242a and the second yoke portion 242b pressed by the elastic member 243 are in contact with the end surface S2 of the void section 24 positioned radially inward.

As described above, when the rotational speed of the motor 1 is equal to or less than the base rotational speed, the elastic member 243 presses the yoke 242, so that a void region portion R1 where the second yoke portion 242b does not exist is formed in the second void portion 24b to prevent the passing of the magnetic flux M2, thereby preventing the short circuit of the magnetic flux M2. As a result, the magnetic flux amount of the magnetic flux M2 is small and the magnetic flux amount of the magnetic flux M1 is large, whereby the motor 1 can increase the magnetic flux amount of the magnetic flux interlinked with the coil 12 during low-speed rotation.

Since the centrifugal force acting on the yoke 242 increases as the rotational speed of the rotor core 21 increases, the centrifugal force, when the rotational speed of the rotor core 21 exceeds the base rotational speed, becomes greater than the elastic force of the elastic member 243 as the rotational speed increases. Therefore, when the rotational speed of the rotor core 21 exceeds the base rotational speed, the elastic member 243 compresses by being pressed by the centrifugal force acting on the yoke 242, with the amount of compression increasing as the rotational speed increases. Then, when the elastic member 243 compresses, the second yoke portion 242b approaches an end surface S3 of the second void portion 24b positioned radially outward.

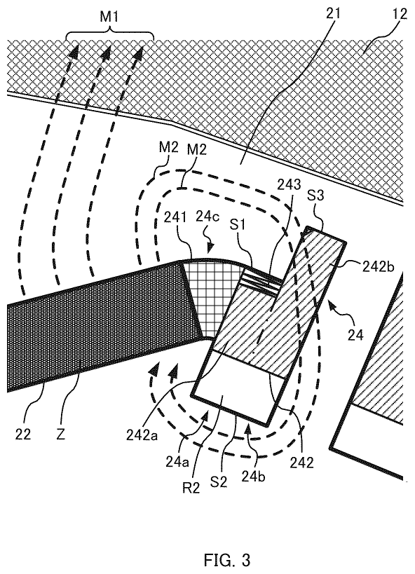

FIG. 3 shows a configuration of the void section 24 when the elastic member 243 compresses the most. When the rotational speed of the motor 1 is high, which is equal to or higher than the base rotational speed (for example, 15000 rpm), the elastic member 243 compresses by being pressed by the centrifugal force acting on the yoke 242, and the second yoke portion 242b contacts the end surface S3, as shown in FIG. 3.

As described above, when the rotational speed of the motor 1 is equal to or higher than the base rotational speed, the amount of compression of the elastic member 243 increases as the rotational speed increases, and thus, the void region portion R1 becomes smaller while a void region portion R2 becomes larger as the rotational speed increases, in the second void portion 24b. Then, as the void region portion R1 becomes smaller, the magnetic flux M2 tends to pass through the second yoke portion 242b more easily to advance toward the end surface of the magnet Z positioned radially inward, and so the magnetic flux amount of the magnetic flux M2 becomes greater while the magnetic flux amount of the magnetic flux M1 becomes smaller. As a result, in the motor 1, the magnetic flux amount of the magnetic flux M2 (leakage magnetic flux) increases as the rotational speed of the motor 1 increases, therefore, the rotational speed of the motor 1 can be increased even when execution of the field weakening control is suppressed, and loss can be reduced by suppressing execution of the field weakening control.

When the second yoke portion 242b and the end surface S3 are in contact with each other, leakage magnetic flux advancing from a region within the rotor core 21 that is closer to the outside than the end surface S3 out of the leakage magnetic flux enters from a direction orthogonal to the end surface S3. Therefore, even if the rotational speed of the motor 1 decreases, the magnetic flux continues to pass through the contact surface of the second yoke portion 242b and the end surface S3, so that a force in a direction opposite to the direction of the elastic force of the elastic member 243 is generated, and thus the yoke 242 is less likely to move toward the inward position in the radial direction. Accordingly, the second yoke portion 242b may be positioned so as not to come into contact with the end surface S3 of the second void portion 24b in the radial direction when the elastic member 243 compresses the most.

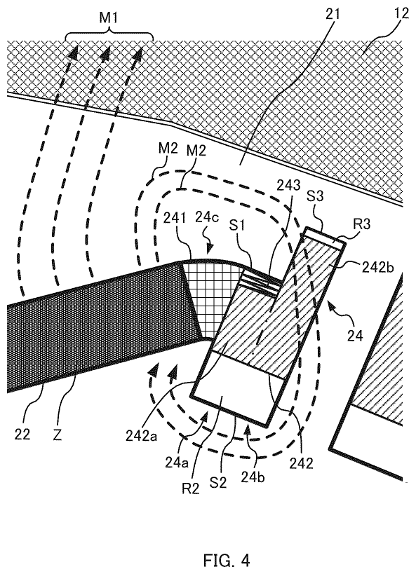

FIG. 4 shows the second yoke portion 242b not in contact with the end surface S3. FIG. 4 shows the elastic member 243 in the most compressed state. As shown in FIG. 4, even when the elastic member 243 is in the most compressed state, the end surface S3 and the second yoke portion 242b do not come into contact with each other, and a void region portion R3 is formed. With this configuration, the motor 1 can prevent the magnetic flux from entering the second yoke portion 242b from a region within the rotor core 21 that is closer to the outside than the second yoke portion 242b in the direction orthogonal to the end surface S3. As a result, when the rotational speed of the motor 1 decreases, the yoke 242 can move toward the inward position in the radial direction according to the rotational speed.

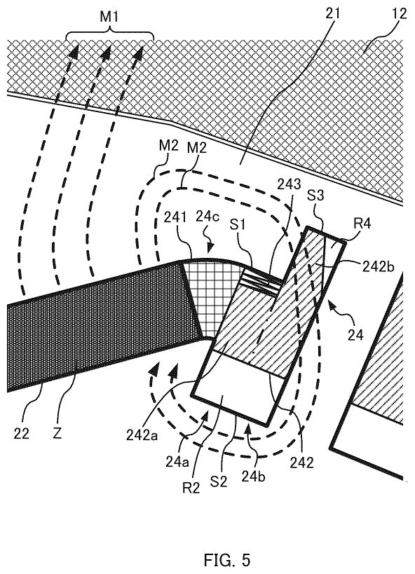

Further, even in a case where the second yoke portion 242b and the end surface S3 are in contact with each other, the area of the second yoke portion 242b in contact with the end surface S3 may be reduced. As an example, the cross-sectional area of the second yoke portion 242b, taken along a plane orthogonal to the radial direction, may be smaller as the distance from the end surface S3 of the second void portion 24b positioned radially outward decreases. FIG. 5 shows the second yoke portion 242b having a smaller area of contact with the end surface S3. FIG. 5 shows the elastic member 243 in the most compressed state.

As shown in FIG. 5, the cross-sectional area of the second yoke portion 242b, taken along a plane orthogonal to the radial direction, becomes smaller toward the radially outward side of the second yoke portion 242b. Even when the elastic member 243 is in the most compressed state, a void region portion R4 is formed between the end surface S3 and a part of the second yoke portion 242b. With this configuration, the motor 1 can suppress magnetic flux from entering the second yoke portion 242b from a region within the rotor core 21 that is closer to the outside than the second yoke portion 242b in the direction orthogonal to the end surface S3. As a result, the yoke 242 tends to move toward the inward position in the radial direction more easily in accordance with the rotational speed when the rotational speed of the motor 1 decreases. Further, the side of the second yoke portion 242b closer to the magnet Z in the circumferential direction comes into contact with the end surface S3, so that the magnetic flux amount of the magnetic flux M2 tends to be increased more easily.

### <Effects of Rotor 20>

As described above, the rotor 20 (interior permanent magnet rotor) includes the rotor core 21 having the plurality of magnet insertion holes 22 formed at predetermined intervals in the circumferential direction and into which the magnets Z are inserted, and the void section 24 communicating with one end of each of the plurality of magnet insertion holes 22, and the yoke 242 provided inside each of the plurality of void sections 24 so as to be movable in the radial direction of the rotor core 21, and the elastic member 243 provided inside each of the plurality of void sections 24 and pressing the yoke 242 in the radial direction.

With the rotor 20 configured in this manner, in the rotor 20, when the rotational speed of the motor 1 is low, which is at or below the base rotational speed, the elastic member 243 presses the yoke 242, so that the void region portion R1 is formed to prevent the passing of the magnetic flux M2, thereby increasing the magnetic flux amount of the magnetic flux M1. On the other hand, in the rotor 20, when the rotational speed of the motor 1 exceeds the base rotational speed, the elastic member 243 compresses due to the centrifugal force acting on the yoke 242 and the void region portion R1 becomes smaller, so that the magnetic flux amount of the magnetic flux M1 becomes smaller and the magnetic flux amount of the magnetic flux M2 becomes larger. As a result of the above, the motor 1 can increase the magnetic flux amount of the magnetic flux M1 interlinked with the coil 12 during low-speed rotation, and can increase the rotational speed of the motor 1 while reducing the loss even when the execution of the field weakening control is suppressed by increasing the magnetic flux M2 during high-speed rotation.

The present disclosure is explained on the basis of the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments of the present disclosure. Further, effects of the new exemplary embodiments brought by the combinations also have the effects of the original exemplary embodiments.

1. An interior permanent magnet rotor comprising:
a rotor core having i) a plurality of magnet insertion holes formed at predetermined intervals in a circumferential direction and into which magnets are inserted and ii) a void section communicating with one end of each of the plurality of magnet insertion holes;
a yoke provided inside each of a plurality of the void sections so as to be movable in a radial direction of the rotor core; and
an elastic member provided inside each of the plurality of the void sections and pressing the yoke in the radial direction.

2. The interior permanent magnet rotor according to claim 1, wherein
the yoke includes i) a first yoke portion located on a side closer to the magnet insertion hole in the circumferential direction, and ii) a second yoke portion that is located on a side farther from the magnet insertion hole in the circumferential direction and is longer than the first yoke portion in the radial direction, and
the elastic member is provided between an end surface of the void section and the first yoke portion along the radial direction.

3. The interior permanent magnet rotor according to claim 2, wherein
the void section includes i) a first void portion located closer to the magnet insertion hole in the circumferential direction and in which the first yoke portion can move in the radial direction and the elastic member can expand and contract, and ii) a second void portion located farther from the magnet insertion hole in the circumferential direction and in which the second yoke portion can move in the radial direction, and
the first yoke portion and the second yoke portion pressed by the elastic member are in contact with an end surface of the void section positioned inward in the radial direction.

4. The interior permanent magnet rotor according to claim 3, wherein
the second yoke portion approaches an end surface of the second void portion positioned outward in the radial direction when the elastic member compresses.

5. The interior permanent magnet rotor according to claim 3, wherein
the second yoke portion is located at a position so as not to come into contact with an end surface of the second void portion in the radial direction when the elastic member compresses the most.

6. The interior permanent magnet rotor according to claim 3, wherein
a cross-sectional area of the second yoke portion, taken along a plane orthogonal to the radial direction, is smaller toward an end surface of the second yoke portion positioned outward in the radial direction.

7. The interior permanent magnet rotor according to claim 1, wherein
when a rotational speed of the rotor core exceeds a base rotational speed, the elastic member compresses by being pressed by a centrifugal force acting on the yoke as the rotational speed increases.

8. The interior permanent magnet rotor according to claim 1, further comprising:
a support part that is provided between the magnet and the elastic member in each of the plurality of void sections to prevent the elastic member from moving toward the magnet.

9. The interior permanent magnet rotor according to claim 1, wherein
an end surface of the void section positioned inward in the radial direction is larger than an end surface of the void section positioned outward in the radial direction.
